(19) United States
(12) Patent Application Publication
(10) Pub. No.: US 2009/0077170 A1
(43) Pub. Date: Mar. 19, 2009

(54) System, Architecture and Method for Real-Time Collaborative Viewing and Modifying of Multimedia

(76) Inventors: Andrew Morton Milburn, New Paltz, NY (US); Thomas Csaba Hajdu, Santa Barbara, CA (US)

Correspondence Address: MATTHEW L. AHART, 10751 WILSHIRE BLVD. #608, LOS ANGELES, CA, 90024, US

(21) Appl. No.: 12/209,281

(22) Filed: Sep. 12, 2008

Related U.S. Application Data
(60) Provisional application No. 60/993,888, filed on Sep. 17, 2007.

(51) Int. Cl. G06F 15/16; G06F 3/00

(52) U.S. Cl. 709/203; 709/205; 715/758

(57) ABSTRACT

A system, architecture and method for real-time viewing and collaborative modification of data is disclosed. The platform utilizes pointers to quickly and efficiently render data at a user location. A mechanism for viewing and disseminating modifications in real-time is disclosed.

### CROSS-REFERENCE TO RELATED AND PRIORITY PATENT APPLICATIONS

This non-provisional patent application claims priority under 35 U.S.C. §119(e) to Provisional U.S. Patent Application No. 60/993,888 filed Sep. 17, 2007 entitled “Provisional Patent Application of Audiofriend for Automated System and Method for Creating Collages of Images, Video and Text”, the contents of which are fully incorporated by reference herein.

### FIELD OF THE INVENTION

The present invention relates to data modification. Specifically, the present invention relates to the sharing and collaborative real-time modification of multimedia data using efficient data management techniques.

### FEDERALLY SPONSORED RESEARCH

Not applicable.

### SEQUENCE LISTING OR PROGRAM

Not applicable.

### BACKGROUND OF THE INVENTION

The present invention relates to the observing and manipulation of data in the digital age. Increasingly, content developers find themselves needing to collaborate with others who are not present at the same physical location. Indeed, with the advent of the World-Wide Web (internet), content developers desire to work with individuals who are located across the world on projects.

The prior art discloses tools that allow individuals to view data remotely. The internet provides one avenue for remote data viewing: content is observed using browsers (e.g., Safari, Internet Explorer, Mozilla, Firefox, and Opera). However, traditional use of web browsers does not allow users to modify the data being viewed.

Recently, some platforms (e.g., MySpace, Friendster) that allow remote users to view data have allowed these users to create “profiles.” A user is allowed to change his/her profile by logging in and submitting changes. However, these platforms are not useful for collaboration because only the person who created the profile is able to make edits. Some platforms, such as blogs, allow multiple users to make comments which are appended to existing internet data. These platforms, however, do not allow different users to make changes to the same data—instead, users can only add comments.

There are collaboration tools that allow multiple users to edit a single piece of source data. However, these tools are resource-intensive and/or do not allow for real-time dissemination of modifications. U.S. Pat. No. 7,143,357 to Snibbe et al describes collaboration whereby a digital media artifact is produced where multiple users can access and modify data remotely. In addition, U.S. Pat. No. 7,234,117 to Zaner et al describes an on-line experience where a group can be on the internet at the same time and view and modify certain media data jointly. These prior art systems rely upon access to source data and the ability to modify this source data directly. Because source data is operated on directly, these systems must store and transmit source data. Unfortunately, because source data can consume large amounts of memory, these platforms are resource-intensive. In other words, these platforms require substantial dedicated storage and bandwidth, which raises operating and start-up costs and slows down performance. Furthermore, in these prior art, users can only add, remove or re-order content; the prior art does not contemplate modifications to the content. Modifications are manipulations to the data that is shown and includes zooming (in or out), adding viewable text, rotating, drawing upon, cropping, distorting, translating (up-down or left-right), stretching, skewing, or excerpting (e.g., for a movie). Modifications do not include changing volume or order of presentation. (As a note, real-time is not exactly instantaneous because information must pass back and forth and be processed, but real-time is close to instantaneous.)

Google Docs (for documents, spreadsheets and presentations) and wikis such as PB Wiki allow users to collaborate on documents, spreadsheets and presentations located on the Internet. However, these resources do not incorporate pointers to efficiently manage bandwidth, nor do they use technology to immediately broadcast updates to documents, nor have they been applied to create a dynamic audiovisual display.

### SUMMARY OF THE INVENTION

The present invention is directed to a system for enabling real-time collaborative data development using efficient data management techniques. The system allows users to work together on a project. The system uses pointers to facilitate faster and less resource-intensive collaborative data development.

Pointers contain the information needed by users to observe the project. Observation can utilize any of the five senses, or any combination of the five senses. For example, the invention is anticipated to be particularly useful for audiovisual projects, combining visual data and audio data. As used herein, the terms “observe”, “render” and “view” are to be understood as not limited to any particular means of sensation or presentation.

In order for a user to view a project, the user requests project information. In a web-based embodiment, this request can come after the user logs in to a secure website and selects a project that (s)he desires to view. Pointer data is provided in response.

At the user's location, a client application receives the pointer data and processes the pointer data to determine what source data is needed and how to render the project data. The client application downloads source data from a source data source that is external to the platform. The client application may be a web browser, a plug-in to a web browser, or a custom application. The client application may be downloaded by the user, particularly on initial set-up.

In one embodiment, the client application is a Flex application. This application can include user interface (UT) code, data managers for room state and user information, business logic, and connections that are real-time (e.g., RTMP or streaming AMF with BlazeDS) or slower (such as plain AMF with Granite DS).

Users are anticipated to be numerous, with any number of them capable of viewing the viewable data at the same time. Where this is the case, users may wish to interact with one another using chat or bulletin-board functionalities. Chat functionality and bulletin-board functionality can be employed using Drupal and Giant Flying Saucer Socket Server. Alternatively, custom chat and/or bulletin-board functionality can be created using well-known programming techniques in Adobe Flex/ActionScript3. Chat can be allowed in two-way or group format. Two-way chat allows a user to send and receives messages from one other user, without these messages being viewed by others. Group chat is similar to a “chat room” or “bulletin board” where all messages written by any user in a given room can be seen by all other users in the same room.

The invention further contemplates users being able to change the modifications to the data and viewing the change in real-time. When a user desires to change a project, the user submits the proposed modifications. When accepted, these changes are immediately transmitted to other users working on the same project so that they may immediately view the updated project.

To facilitate real-time collaboration, a mechanism for disseminating changes to the data is provided. A multi-threaded media server can be used to broadcast changes to all users working on a project. It may be desirable to use Real Time Messaging Protocol (RTMP) with the server. Servers such as Adobe Flash Media Server and Wowza Media Server are commercially available. Additional servers may be desired to perform core back-end and storage functions. Alternatively, a media server may use streaming Action Message Format (AMF) and BlazeDS to transmit real-time information between the server and users. AMF is known to persons of skill in the art as the fastest way to send and receive data to a Flash player. A JBoss server may be used as the media server in this embodiment. One of skill in the art will also recognize that RTMP-Wowza and AMF-JBoss implementations are only two of many possibilities.

Finally, an HTML client may be provided for basic administrative functions. Because these functions are usually not as time-dependent as the user-provided clients, JSP may be used. Independent Claims

A system for real-time collaborative viewing and modification of multimedia data comprising multimedia data in pointer format; a first client that can view and change said multimedia data; a second client that can view and change said multimedia data; a media server; a first communication link connecting said first client to said media server in real-time; a second communication link connecting said second client to said media server in real-time; a database for storing said multimedia data; and a third communication link connecting said media server to said database.

A server-side architecture for real-time collaborative viewing and modification of multimedia data comprising a media server; a communication link connecting said media server to the internet, wherein said communication link connects said media server to at least two clients in real-time; a database server for storing multimedia data, wherein said multimedia data is in pointer format and contains links, ordering and modifications; and a communication link connecting said database server to said media server.

A method for real-time collaborative viewing and modification of multimedia data comprising allowing a first user to enter a project room; allowing a second user to enter a project room; transmitting project data in pointer format to said first user's client; transmitting project data in pointer format to said second user's client; accepting modifications to said project data from said first user; and transmitting updated project data to said second user in real-time.

A method for real-time collaborative viewing and modification of multimedia data comprising allowing a first user to view multimedia data; allowing a second user to view multimedia data; transmitting data in pointer format to said first user's client; transmitting data in pointer format to said second user's client; accepting modifications to said project data from said first user; and transmitting updated project data to said second user in real-time.

### BRIEF DESCRIPTION OF THE DRAWINGS

FIG. 1 illustrates the data flow in one embodiment of the invention.

FIG. 2 shows the principal parts of a system practicing the invention, where the media server is separate from the server.

FIG. 3 illustrates the updating process in one embodiment of the invention.

FIG. 4 illustrates the components of the client in one embodiment of the invention.

FIG. 5 illustrates the components of the server in one embodiment of the invention.

FIG. 6 illustrates the server-side architecture in one embodiment of the invention.

FIG. 7 illustrates the client-server architecture in one embodiment of the invention.

### DETAILED DESCRIPTION OF PREFERRED EMBODIMENTS

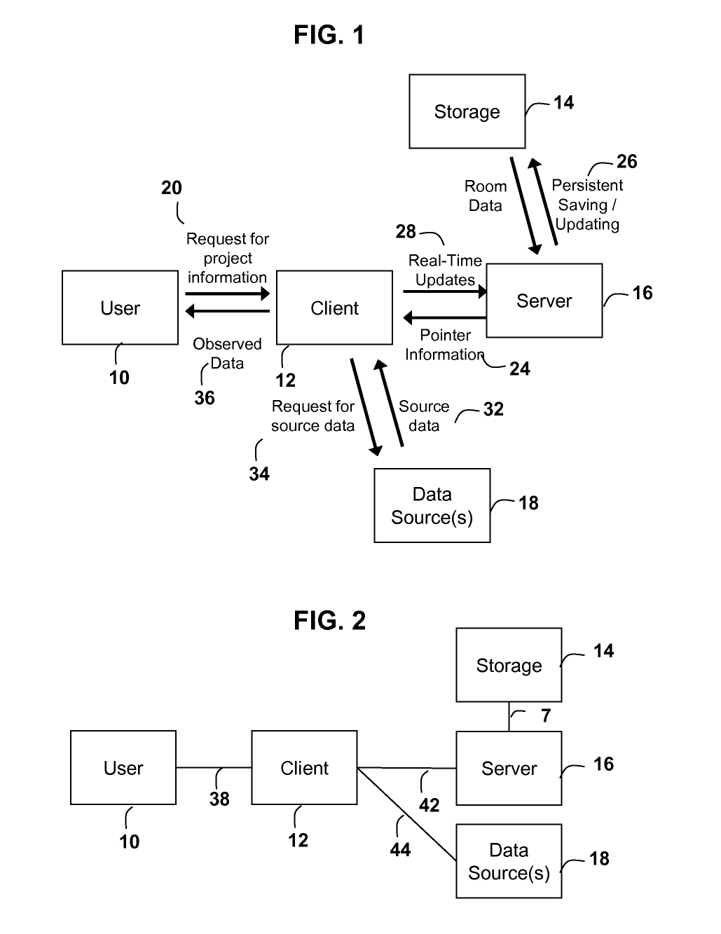

Turning to FIGS. 1 and 2, a user 10 desiring to participate in collaborative real-time data development uses a client 12 to access a project. The user is operatively connected to the client. The interactive connection 38 can be facilitated using a keyboard as a user input mechanism. Any user input mechanism is acceptable, options include keyboard input, a USB connection for streaming data input, mouse input (click, movement, drag/drop, double-click, etc.), microphone and sound recording, microphone and voice recognition, etc. The user is also able to observe the project via the interactive connection 38, which can include a display panel, speakers, a mechanism for physical sensations, or any combination thereof

To begin working on a project, a user may log in to the system using a previously established userid (or email address) and password. The user then enters a request for project information 20 to the client and submits the request to the system. The client application processes this request and submits a request for project information 22 to the server 16. The server may have pointer information 24 cached, or it may have to access storage 14 to obtain the information. The server 16 returns pointer information 24 to the client 12. The directions for how to display the linked information are derived from the pointer data 24.

The pointer data will include identification of external data source(s) 18. The client application directly accesses external source data 32 from external data source(s) 18. External source data 32 is obtained after the client sends a request for source data 34 to a data source. Source data may also accompany the pointer data, although this will be infrequent as this will require additional bandwidth. The advantage that the server does not, as a general rule, traffic directly in source data is advantageous both because (1) it limits copyright usage issues as well as (2) it reduces the amount of data that must be handled by the server.

The client renders observed data 36 by processing source data 32. The observed data 36 may include some of the pointer data as it is stored or the viewable data may be the result of a transformation of the pointer data. For example, if a user observes the viewable data using a web browser and pointer data is stored in comma-separated value format, the pointer data may be transformed into HTML or Flash format for better presentation. Alternatively, pointer data may define scents or physical (touch) sensations, in which case the pointer data will have to be transformed by the client application (e.g., 001=onion scent, 002=apple scent) to produce the scent or physical movement that the user can smell or feel.

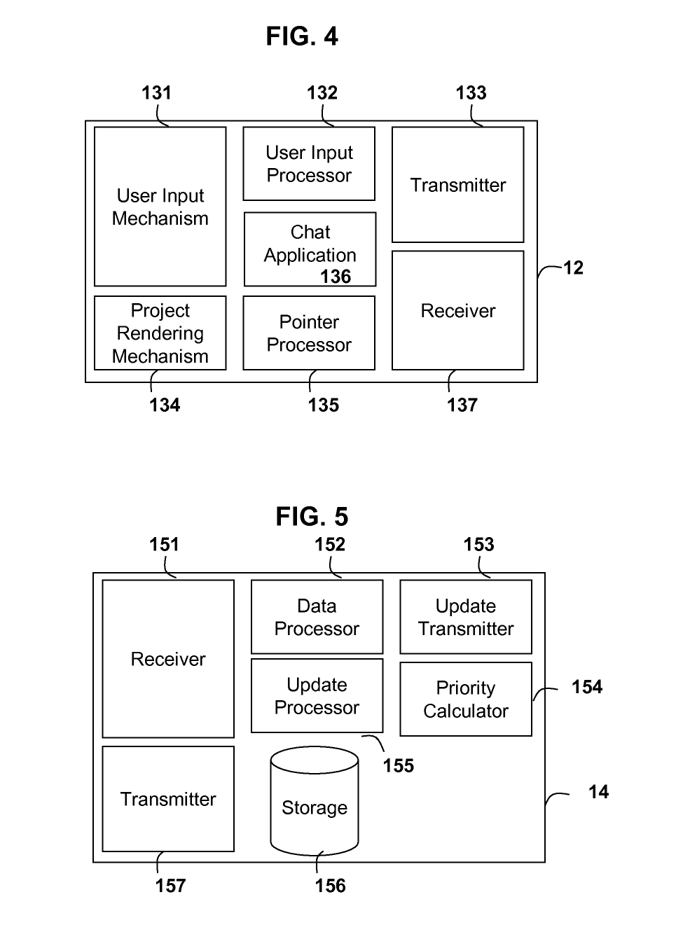

FIG. 4 shows the components of the client 12 in one embodiment. Observed data 36 is output from the client using a project rendering mechanism 134. The observed data can be rendered using a monitor or display panel for visual representations of data, speakers for sound, a joystick or other device capable of simulating physical movement for touch-sensation, or a scent-producer for olfactory sensation. It is anticipated that in a common embodiment of the invention, the client will run on a personal computer, with user input via keyboard and mouse, and output rendered using a display screen and speakers for sound.

In one embodiment, source data is always available from public data sources 18 and therefore the use of data as described will neither run afoul of copyright laws nor present confidentiality or privacy concerns. However, the invention herein described is not limited to public source data because a private entity may wish to utilize the present invention as a means for efficient collaboration on a private project.

### Updating and Preview

A user's suggested changes may be translated into suggested changes to the pointer. These suggested changes can then be submitted to the central facility. The central facility may then update the pointer, either automatically accepting the proposed modifications or utilizing an algorithm to determine whether to update the pointer. It is also possible for a user to preview changes to the manipulations on his/her computer and view the resulting change in real-time before submission.

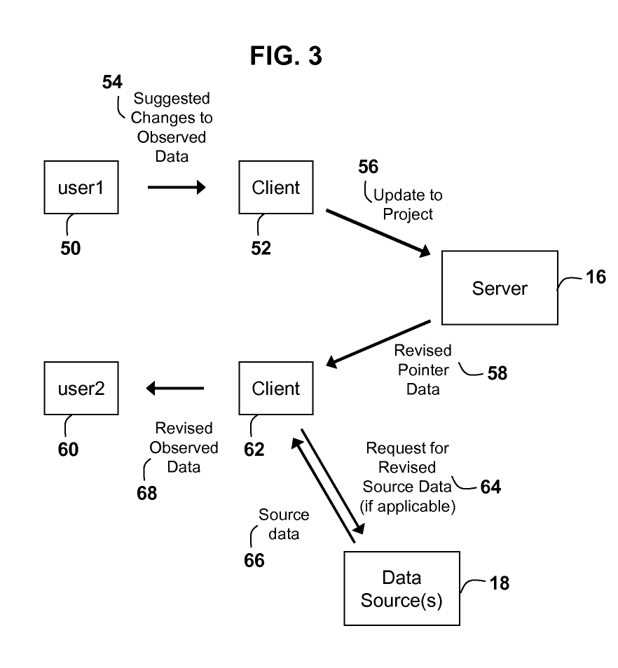

FIG. 3 illustrates one embodiment of the process of updating a project in real-time and broadcasting the update to all users working on a project. Initially, a first user 50 and a second user 60 are each logged-in and accessing a project. The first user enters suggested changes to observed data 54 to his/her client 52. The client then submits the suggested changes 56 to the server 16. The suggested changes could be in the form of new pointer data or in the form of changes to pointer data. The server is interactively connected to clients for all users working on the project. The server sends revised pointer data 58 to the second user's client 62. The second user's client processes the revised pointer data, requests revised source data 64 and obtains new source data 66 from a data source 18 if the source data is changed. The client 62 then renders the revised observable data 68 for viewing by the second user 60.

The revised pointer data 58 could be the changes from the previous pointer, a new pointer entirely, or something in between. For example, if the revision is to shrink a picture by 50% in the horizontal dimension, the revised pointer data 58 could merely indicate the picture, and that it is to be shrunk 50% in the horizontal dimension. Alternatively, the entire set of data for the entire project could be re-sent, with the revision made to the picture's modifications. Or, anything in between can be provided.

### The Client Application

The client application can be a program that can be installed on a personal computer or mobile phone or personal data assistant (PDA) or any other device. The client application interacts with the platform's server and data source(s) and also presents the project in observable form. In one embodiment, the client application is a web browser, or a web browser with certain plug-ins.

Once input is received, the client 12 processes user input using a user input processor 132. The user input processor may convert the user input into a more usable format. It may also contain a priority calculator that may determine whether to accept user input or not. A priority calculator uses rules to determine whether to accept user input, and does not accept all suggestions. Once user input has been processed it is passed to a pointer processor 135 as well as a transmitter 133. The pointer processor processes data to determine how to represent data for a project. For example, if a pointer contains links to source data and information defining how to manipulate the source data, the pointer processor converts this information into the input needed for the project rendering mechanism 134 to properly render the project. The pointer processor can process original, unedited, pointer data to represent a project (e.g., once a user enters a “room”), and it can also process changes to pointer data when the user or another user makes a change to the project data.

As mentioned above, processed user input is passed to a transmitter 133. The transmitter 133 transmits user input to the server 16. The transmitter can transmit initial requests for project data as well as changes to the project data.

The client application may be a Rich Internet Application (RIA). The client application for receiving pointer data and rendering observed data can be authored using HTML, Flash/ActionScript, Java, JavaScript, or other programming languages for use with an internet browser.

Alternatively, proprietary software that a user installs at his/her location may be used. For example, a person of skill in the programming art could write a proprietary program that provides similar functionality to an internet browser carrying out these functions. It may be desirable to write proprietary software when an intranet is used or when security is of particular importance.

The client application is designed to do as much of the rendering and media manipulation work as possible using the user's local machine, thereby reducing the load on the platform's servers as much as possible. The platform's server rarely traffics in the media directly; it traffics in the “pointers” to media resident on 3d party servers, which may be expressed as URLs. The exceptions to this are user-uploaded content and user-resident content. User-uploaded content may be stored on the platform, either in a server or in storage that is accessible by a server. User-resident content may be stored at the user's location. Examples of user-provided content are webcam feeds, text, and pictures. User-provided content is downloaded by other users directly from the user providing the content, or it may be stored on the server.

The client also includes a receiver 137. The receiver 137 receives information from the server 14. This information includes the project pointer information when a user initially begins work on the collaboration. Also, the client receives changes to the project from the server when another user has submitted a change to the project. In one embodiment of the invention, the receiver and transmitter are implemented using an internet browser and an internet connection.

The client 12 also may include a chat application 136. The chat application allows a user to communicate with one or more other users (using 2-way or group chat) who are working or viewing the same project. In one embodiment of the invention, the chat application is embedded in an internet browser.

The client is operatively connected to a server using a communication link 42. The client is also operatively connected to data sources using at least one communication link 44.

### The Server

FIG. 5 illustrates one embodiment of the server 14. The server has a receiver 151 that receives information from the client. When the server receives information, it processes this information using a data processor 152. The actions of the data processor depend on what the client is attempting to accomplish. As an example, when a user first seeks to view a project, the user will send a request to the server for project information. The data processor will read in the user's request and will access storage 156 to look up the project information. For an original request for project data, this project data will then be passed to the transmitter 157 and sent to the client.

The server also has a transmitter 153 which can be used to transmit updates. The update transmitter may be the same as the transmitter 157. Similarly, the server may also have an update processor 155 which processes update information that is received. This processing can be used to update stored pointer information.

The server may also include a priority calculator 154. This priority calculator can determine whether to accept changes to project data considering the priority scheme for the project. A priority calculator located at the server will work best for determining what changes to make permanent for a project because the server has access to storage where project data is retained and accessible in the future. A priority calculator at the server will be more secure than a priority calculator running in the client 12.

A database server 156 is shown in FIG. 5. In one embodiment of the invention, storage is made using a database application, such as a MySQL or MS SQL. SQL queries can then read from and write to the database. The database server can be part of the same physical server that is the media server, or it may be a separate server.

FIGS. 1-3 show an embodiment where storage is separate from the server that handles client interactions. In fact, multiple servers may be desired. Throughout this specification, the term “server” may refer to a single server performing all functions, or it may refer to multiple servers where functionality is spread across more than one server. Such a system may be distributed, and multiple servers may not even be located at the same physical facility.

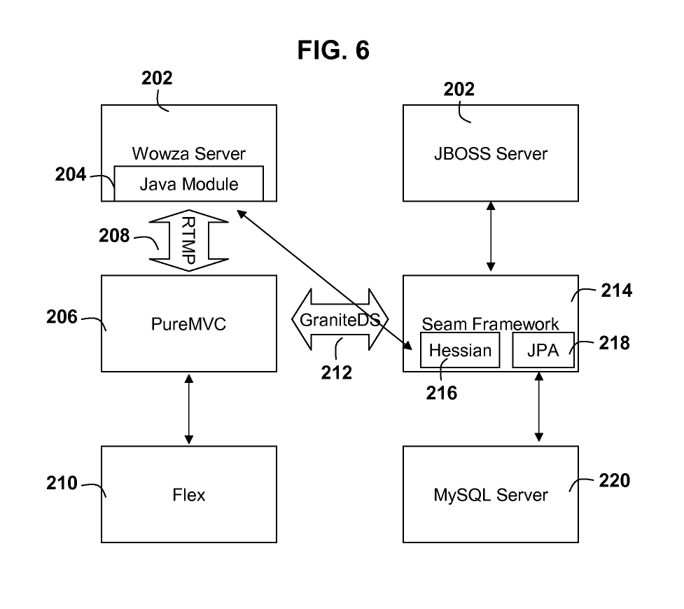

As an example, FIG. 6 shows the server-side architecture of the invention in one embodiment. Three servers are used. First, a JBOSS server 202 manages core back-end processes. The JBOSS server has a Seam framework 214. The Seam framework utilizes JPA 218 to access and manage data, including interactions with a MySQL server 220 that stores persistent project information. Most of the communication between the core back-end and the real-time module consists in synchronization, data persistence, and administrative operations. For these purposes, the binary protocol Hessian 216 is used. In addition, a Wowza media server 202 with a Java module 204 is also used to manage multiple threads and real-time processing. Real Time Messaging Protocol (RTMP) 208 is used to communicate in a model-view-controller (MVC) framework. PureMVC 206 provides the framework for Flex 10 applications that are then passed along to the client.

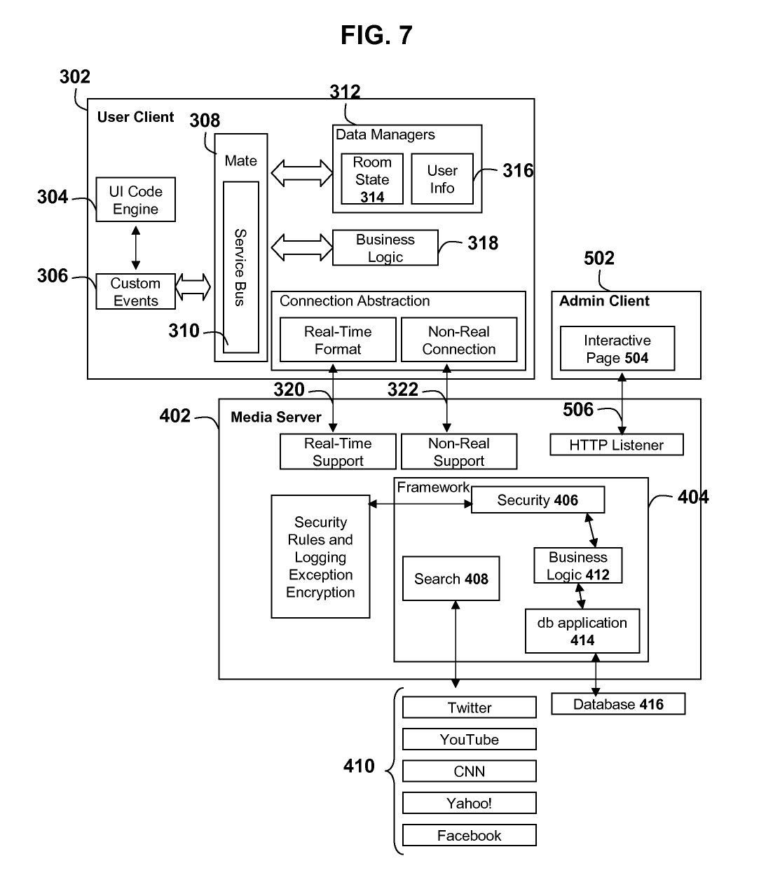

There are innumerable ways of building a client engine. In one embodiment, shown in FIG. 7, a user client 302 contains a user interface engine 304. In one embodiment a model-view-controller (MVC) framework can be used. FIG. 7 shows a framework using a Service Bus/Mate embodiment, which is preferable when Flex is being used. In addition to pre-arranged events, Custom Events 306 can be used for login or search to optimize the production. Data managers 312 control room state 314 and manage user information 316. Business logic 318 is used for interaction between the server and UT via the Service Bus/Mate. In one embodiment, the user client can be written using Flex.

Connections between the user client 302 and the media server 402. A real-time connection 320 is used to transmit information that needs immediate dissemination, such as modifications and chat. The real-time connection may be persistent and it may be (from the server's standpoint) multi-threaded. A real-time format or protocol 320 is used, such as RTMP or streaming AMF to facilitate this real-time connection. A non-real-time connection 322 is also present. This non-real time connection 322 may use the same physical connection (e.g., internet access) as the real-time connection. The non-real time connection may use plain AMF for implementation.

The media server 402 may take advantage of known applications and libraries to support these real-time and non-real time connections. For example, BlazeDS is a library that runs on a java server that facilitates setting up a protocol that for real-time communication with clients. In addition, minor changes, like account preferences can be easily passed through BlazeDS. Similarly, the non-real connection can take advantage of known applications and libraries. For example, GraniteDS offers very good integration with Java services, making it useful here. It is also possible for the non-real time connections to be implemented as part of the real-time connections.

There are countless possible implementations of the media server. In one embodiment, the media server 402 may also utilize a web framework 404. The inventors are using Seam as part of an embodiment they are building. The framework provides various features quite easily. One such feature is security 406. Security is provided for many aspects, including user authentication and login, ensuring that a user is authorized to have a certain action performed, and to protect against hacking. In addition, security can provide encryption (one-way or two-way) for passwords or sensitive information. SSL, for example, can be used for some encryption purposes. In addition, the web framework may support a search feature 408. The search may be a federated search, where multiple sources are managed and aggregated on behalf of the user, or it may search a simple database. The search feature accesses data sources 410 such as Twitter, YouTube, CNN, Yahoo!, and Facebook. The media server also utilizes business logic 412 for efficient programming. A database library/application 414 can be used to facilitate connections and communication with a database 416. Database access can be structure in any manner possible. One possibility is to use two parts, such as using Java Persistence API (JPA) and Hibernate as a lower layer. An admin client 502 may also be provided. The admin client 502 has interactive web page(s) 504 and is connected to the media server using a communication link 506.

### Pointers

Pointers may contain link information that designates the location of source data. Source data can be present at a source outside the platform such as an external data source, it may be stored within the platform, or it may be present at the user's location. Currently, there are many available external data sources that store massive amounts of data and which are highly useful. Such sources include Flickr, Youtube, Amazon (CD Covers), PhotoBucket, Odeo, and GoogleVideo.

Pointers may also define modifications that are made to source data. The pointer is digital data and can be in any format, including ASCII text, HTML, Flash, comma-separated values, or SQL data. This list of data formats is not exclusive and persons of skill in the art will understand that other data formats may be used.

Text source data presents a unique situation as text may be included within pointer information or it may be separate source data. The system can handle text in either capacity.

### Community Government/Policing

One aspect of a collaborative development project is to determine which proposed modifications to accept and which to reject. The system can include a priority calculator to determine whether to accept some or all proposed modifications. The decision whether to accept or reject a suggested modification can be made in the client application or at the server level, or in a combination of these locations.

There are broadly two things which must be controlled by a priority calculator. Objectionable behavior (abuse of the controls of the room—excessive destruction and deletion of the collaborative content, etc.) and objectionable content (spam, obscenity/pornography, hate speech/fighting words).

There are several principal governmental modes that may be employed. The first is a “free” or “wiki” mode in which any user can add or delete any media from a room at any time. Any user can change any parameter or the connection of that parameter to music analysis at any time.

Another is “rotisserie” in which an adjustable subset of control decisions (what does into/is removed from the “playlist”, which images are “deleted”, etc) is rotated among the users in a fixed order. Should a user fail to exercise his/her option of control on his/her “turn”, after an adjustable period of time, control passes to the next user in the rotation.

Another is “merit-based”, in which users rate each other's contributions to the room. Users with higher ratings are given higher priority in making control decisions.

Another is “democratic”, in which users vote on an adjustable subset of control decisions. Changes must be approved by a minimum voting amount, such as a majority.

Another is “free with complaints”, which is the same as “free” except users are allowed to file complaints against objectionable submissions or behavior. If an adjustable minimum number of complaints are received, a user's control decisions are blocked. If the complaints reach a sufficient level, the user may ultimately be blocked from the site.

Another is “free with policing”, which is the same as “free with complaints” except that the complaints are vetted by a staff of editors which we maintain to enforce content and behavior policies as we evolve them to maintain a safe and useful community.

Another is “solo”, where only one person can make changes.

Another is “clan”, where only the author and his/her friends or appointees can make changes.

Another is “duel”, where only two people can change anything , in a split-screen mode. Other users can vote democratically to replace one of the duelists with someone else from the room.

In addition to the initial acceptance/rejection of user input, the invention contemplates a system for identifying and removing objectionable content (obscene or pornographic material, hate speech or fighting words, or spam). There may be a system of user-policing, in which any user can flag as objectionable a piece of content. If a certain minimum number (to be determined) of users flags a piece of content, it can be automatically removed. Furthermore, the users responsible for the objectionable content should be warned and records kept of these transgressions so that we may ultimately ban the users from further use of the system. Using IP addresses is an imperfect but widespread technique for recognizing individual users for purposes of such banning. Alternatively, an embodiment may employ a system of staff policing and vetting of content. Alternatively, a combination of these two methods may prove most effective at reducing the amount of objectionable content in the site.

Furthermore, it may be useful to maintain some projects (or “rooms”) which use only content vetted by staff or other means—such rooms would be safer for children to occupy and play with, for example.

Finally, in all instances, the permission to make changes can be further restricted by the room's original author. For example, an original author can make a Free room, but she can prevent anyone from making changes to the color palette, or she can make a Rotisserie, but prevent anyone from ever deleting an image or video.

### Templates

It is also possible for a user's experience to be facilitated using a template. A template guides a user in creating and changing a project. A template can suggest changes or additions of data where appropriate and desired. Depending on the nature of the template, a template could result in the same project differing each time it is viewed.

### Stochastic Effects

A project, or “room” can either be “stochastic” or “scripted”. Stochastic rooms allow the various modifying parameters (position of objects, colors, etc) to vary randomly, within guidelines establish by the governing templates of the room. This variation is dynamic and always unfolding, the appearance of the room is ever-changing and never quite the same as it has been before. Scripted rooms set the parameters in precise ways. Moreover, these scripts are temporal in nature—changes to the various parameters are recorded in real time, they are anchored to a timeline. This timeline is derived from the primary media in the room, which is usually either an mp3 file or a Flash video file (flv).

Where randomness is involved, the randomness can be created at the client or on the server. If the randomness is generated at the client, the project-rendering information can be synchronized across all users in a room via RTMP/streaming AMF. Or, if desired, randomness can be allowed separately at each user location, in which case different users in the same room will observe different effects.

### Searching

In addition, one embodiment of the invention allows a user to search for content. In this embodiment, a library is maintained where data (or data sources) are associated with keywords. For example, photographs of prominent baseball players, movie clips of famous World Series games, and sound clips by prominent sports journalists can be associated with the term “baseball”. This search capability improves a user's experience by allowing the user to locate data of interest more readily. Federated search, whereby different databases or libraries that are searched are combined by the system, may also be used.

The invention described can be applied in many fields. The embodiments described below are not intended to limit the invention, but rather to provide substance and illustrate potential uses.

### First Embodiment

The inventors contemplate the invention being especially useful for creating audiovisual collages. Such a collage can incorporate text, images, graphics, video, and music as source data. In addition, effects can be incorporated into the collage. The effects can be applied to the text, images, graphics, video, and music to manipulate the data, creating an aesthetically satisfying and desirable result. Effects include zooming (in or out), cropping, ordering, distortion, stretching, skewing, and rotating. The invention is understood to contemplate other audiovisual effects, and not be limited to this list.

In Islands of Consciousness, available at http://incubator.quasimondo.com/flash/islands_of_consciousnes.php, a collage is created by combining music and images from Flickr. However, Islands of Consciousness does not provide the ability for users to modify the resulting collage, nor does it allow multiple users to interact and each participate in the creative process.

In one embodiment of the invention, the world-wide web allows users located anywhere in the world to manipulate data to create, view, manipulate and modify collages. Users access the internet on computers using an internet service provider such as America On-Line and view internet content using an internet browser. Internet access can be achieved via cable modem, DSL, T1, and dial-up modem.

The end-users can visit a website that is the central platform for collaboration on an audiovisual collage. The website has a landing page which presents a variety of rooms in which users are working on different collages. When an end-user accesses the website, he or she can either create a new collage or view an existing collage by selecting a collage from available collages. This selection can be from a list or using a search or a combination of searching and organizational hierarchy.

After selecting a room and after a log-in process, the user is taken into a room. In this room, the user can view and edit collages.

When an end-user selects a collage for viewing, the user submits a request for the information describing that collage to the platform. The platform accesses storage, which may be within a server or in storage accessible from a server, to locate this information. The collage information is stored as pointer information, which is sent from the website's server to the user's client. The pointer information includes link information to direct the user to the source data that is part of the collage as well as modification information that determines how the source data is modified in the rendered collage. The client application reads the pointer information, determines what source data is needed, and then requests the source data from its location(s). The user obtains the source data from a different location (e.g., Flickr) and the collage is rendered by the client application on his/her computer using this source data.

A user can modify the collage by adding, changing or removing source data, or adding changing or removing effects. When source data is added, new link information is added to a pointer. However, because source data may not always be readily available from a source, the platform may include limited storage capacity. Webcam recordings and text are examples of data that may not be readily available from external public sources and the system may store.

Changes to the collage are broadcast to others who are working on the same project (in the same room) as the user. This broadcasting may occur via a multi-threaded media server. The broadcasting occurs almost instantaneously with the submission of a change by the user. Such a broadcast can take less than one second to reach other users. Changes can be broadcast either as a replacement for an initial pointer or as changes to a pointer. For example, if a pointer is a compilation of photographs and originally starts with photographs of Washington, Adams and Jefferson, the addition of a photograph of Madison at the end could be transmitted either as a note to add Madison to the end or as a pointer describing four photographs of Washington, Adams, Jefferson and Madison. It is anticipated that collages will be of greater complexity than merely photographs, such as a combination of photographs, effects, video, text, and music, but the distinction between transmitting changes to existing pointers or the entire revised pointer remains a choice in implementation of the invention. It is even possible that, for some changes some information will be transmitted only as changes to existing data; for other changes the revised data will be transmitted entirely.

In one embodiment of the invention, the client application consists of a “stage”, which is a single two-dimensional area on which media is montaged and displayed. The application maintains a list of media to be displayed on the stage, and this list is kept synchronous with all other users in the same “room” by sending simple XML messages describing the contents of this list anytime a client makes a change to it.

In addition, for each piece of media, the client application maintains a description of ways in which the particular piece of media is modified (resized, animated, distorted, recolored, etc).

The client application applies these modifications to the media itself. Any changes to this description made by the user (through choices in the interface) are broadcast to all other connected users, so the appearance of the media is maintained across all the users in the room.

In addition, the client application maintains information on the ways in which the media on the stage is arranged and otherwise modified (filtered, stretched, rotated, skewed, animated, etc). The client application applies these modifications to the media itself. Any changes to this description made by the user (through choices in the interface) are broadcast to all other connected users, so the appearance of the media is maintained across all the users in the room.

The client application may also allow the user to make changes to the relative volume levels of any audio media playing in the room, and then broadcasts these changes to all connected users.

The client application also maintains a “playlist”, which is a queue of audio and video media scheduled for playback in the room. Any user can make changes to the order and content of this playlist (mediated optionally by governmental controls—see section on “Community Government”) The client application makes any changes to this list as directed by the user and then broadcasts these changes in the form of XML messages to all connected users.

In addition, the client application maintains a description of which visual parameters (size/scale, position on screen, color, etc) are to be controlled by a real-time analysis of the music or audio being played on the stage at any given time. The client application makes any changes to this description as directed by the user, and then broadcasts these changes in the form of XML messages to all connected users. Other parameters can be chosen to be “controlled” by simple oscillators, random functions, or fixed values, all of which are maintained by the client application.

Furthermore, in one embodiment of the invention the client application performs a real-time analysis of the audio output and modifies the selected graphics parameters according to this analysis, once per “frame”, resulting in a continual animation of the stage's media, in synchronization with and related to the music or audio being played by the application. Rather than attempting to perfectly synchronize the audio-visual performance of changes on the stages of all connected users, the local performance of the stage is carefully synchronized to the local playback of the audio.

### Video-DJ

In this invention, it is possible to integrate effects that are used in video DJ-ing. For example, users are allowed to incorporate video clips. These video clips may include music. New music can be substituted or provided to accompany a clip. In addition, a clip can be incorporated in its entirety, or only an excerpt can be incorporated. A user can choose to arrange clips to play in a specific order or he can allow the order of play to be randomized. Or, it is possible to have some clips play in an order, and others be randomized.

### Vector Graphics Overlay

Another effect is overlay. A vector graphics overlay is the imposition of a pattern, such as a psychedelic, over graphics. This can mask arbitrary images or images that sit behind the overlay in the alpha channel. The overlay can change with time, by rotating, moving, evolving or animating, to create intriguing visual effects.

### Framing

In addition, for presentation, it is possible to affect the presentation of images in special manners. Cropping, as discussed elsewhere, is a simplified effect. A square, square-with-rounded-edge, or round (circular or elliptical) frame can be placed around an image. In addition, distortion and fuzziness can be used, for example on the edges of an image or movie clip.

### Interface: Keyboard and Mouse

A traditional computer interface may be used. On a keyboard, shortcut buttons (e.g., press of a single key) can be used whereby a user pecks a key on a keyboard and the effects or images are changed. This will allow a user to fiddle around, changing the image at his/her whim. In addition, a user can even “perform” by changing effects and media inputs using button presses. Alternatively, there could be a “wrestling match” where two users each work in the same room and each one's effects is built on the other's. Function keys could be used for this, or the entire keyboard could be mapped to different functions for this.

### Interface: Mobile

Increasingly, users use mobile devices (e.g., PDAs) to access the internet and perform work that formerly required large programming and interface capability. In this embodiment, a mobile user will be able to access a project/room using his/her mobile device. Where a mobile device is sufficiently robust, the full experience will be made available. Other times, where a mobile device does not have the same functionality or access as a traditional interface mechanism, a simplified version of the client interface will be provided. By detecting the interface device, the correct version of the client program can be provided.

A simplified version will provided limited, but key, functionality. For example, the ability to manage images will be provided, and where a large number of images is available, movement of a mouse or pointing device will result in magnification of the localized image, thus allowing improved viewing of images or other graphics where an interface device has a smaller screen. The user can then drag-and-drop the image onto a workspace for inclusion. (It is to be noted that this magnification and drag-and-drop functionality can also be used on a normal interface.) The room can be saved while the user is working remotely; the user can do more extensive work when he has fuller access later.

Geotagging is also possible. Geotagging involves taking information about a user's location (such as provided by a GPS device) and then using this for the project. For example, a user located in Beijing accessing a room could be given ready access to images related to the Olympics or Chinese culture. Mobile devices increasingly make the user's location available, thus allowing the system to easily recognize the user's location and make appropriate suggestions for content, based on geography and local culture. These suggestions could be incorporated into the search functionality described earlier.

### Second Embodiment

The invention can be utilized to create a video news segment. Users can contribute data and change manipulations on the data. For example, after an event, such as sporting event, a new project could be created for the sporting event.

Then, users could contribute images and video from the event to the project. Other users (or the same users) could edit the images and video for presentation. Still other users (or the same users) could then provide and/or edit dialogue.

Editorial oversight could be maintained by an overarching “editor”, or it could be community-driven by voting and priority rules (as discussed above).

Once complete, the news segment could be distributed. This embodiment would allow for rapid production and cooperation of a diverse set of individuals.

### Third Embodiment

The invention can also be applied to the game industry. Adults and children enjoy putting together jigsaw puzzles using puzzle pieces. An image that is the basis for such a puzzle could be drawn from any source. The project is the process of filling in the puzzle.

Multiple users could participate in the puzzle-completion process.

The platform could, using a randomization engine, cut an image file into jigsaw puzzle pieces. Users would be able to view the puzzle pieces and the progress on putting the puzzle together, and users could suggest placing a puzzle in a position in the puzzle.

Templates could be used to suggest puzzle pieces to place. For example, pieces with straight edges could be suggested for borders. Alternatively, pieces could be suggested for placement adjacent to other pieces with similar colors.

The accept/reject decision would be determined by whether the puzzle piece fit with adjacent pieces. If the puzzle piece did not fit a rejection would be made.

### Conclusion

It is to be understood that other embodiments may be utilized and structural and functional changes may be made without departing from the scope of the present invention. The foregoing descriptions of embodiments of the invention have been presented for the purposes of illustration and description. It is not intended to be exhaustive or to limit the invention to the precise forms disclosed. Accordingly, many modifications and variations are possible in light of the above teachings. For example, the present invention can be modified for application in medical imaging. The project can be an image or other representation of a patient constructed from numerous sources including a treating physician, sphygmomanometer, Doppler blood-flow imager, MRI, etc. It is therefore intended that the scope of the invention be limited not by this detailed description.

The invention claimed is:

1. A system for real-time collaborative viewing and modification of multimedia data comprising:
multimedia data in pointer format;
a first client that can view and change said multimedia data;
a second client that can view and change said multimedia data;
a media server;
a first communication link connecting said first client to said media server in real-time;
a second communication link connecting said second client to said media server in real-time;
a database for storing said multimedia data; and
a third communication link connecting said media server to said database.

2. The system of claim 1 wherein said first client and said second client are downloadable from said media server.

3. The system of claim 1 wherein changes to multimedia data include modifications.

4. The system of claim 3 wherein said multimedia data define an audiovisual collage.

5. The system of claim 3 wherein said modifications include zooming.

6. The system of claim 3 wherein said modifications include adding viewable text.

7. The system of claim 3 wherein said modifications include drawing.

8. The system of claim 3 wherein said modifications include cropping.

9. The system of claim 3 wherein said modifications include distorting.

10. The system of claim 3 wherein said modifications include stretching.

11. The system of claim 3 wherein said modifications include skewing.

12. The system of claim 3 wherein said modifications include translating.

13. The system of claim 3 wherein said modifications include rotating.

14. The system of claim 3 wherein said client program includes previewing.

15. The system of claim 3 wherein said client program includes federated search.

16. The system of claim 3 further comprising a chat application.

17. A server-side architecture for real-time collaborative viewing and modification of multimedia data comprising:
a media server;
a communication link connecting said media server to the internet, wherein said communication link connects said media server to at least two clients in real-time;
a database server for storing multimedia data, wherein said multimedia data is in pointer format and contains links, ordering and modifications; and
a communication link connecting said database server to said media server.

18. The server-side architecture of claim 17 further comprising a client application downloadable by said at least two clients that allows said at least two clients to view said multimedia data and suggest changes to said multimedia data.

19. The architecture of claim 17 wherein said multimedia data define an audiovisual collage.

20. The architecture of claim 17 wherein connections between said media server and said at least two clients in real-time are persistent.

21. The architecture of claim 17 wherein said modifications include zooming.

22. The architecture of claim 17 wherein said modifications include adding viewable text.

23. The architecture of claim 17 wherein said modifications include drawing.

24. The architecture of claim 17 wherein said modifications include cropping.

25. The architecture of claim 17 wherein said modifications include distorting.

26. The architecture of claim 17 wherein said modifications include stretching.

27. The architecture of claim 17 wherein said modifications include skewing.

28. The architecture of claim 17 wherein said modifications include translating.

29. The architecture of claim 17 wherein said modifications include rotating.

30. The architecture of claim 17 wherein said client program includes previewing.

31. The architecture of claim 17 wherein said client program includes federated search.

32. The architecture of claim 17 further comprising a chat application.

33. A method for real-time collaborative viewing and modification of multimedia data comprising:
allowing a first user to enter a project room;
allowing a second user to enter a project room;
transmitting project data in pointer format to said first user's client;
transmitting project data in pointer format to said second user's client;
accepting modifications to said project data from said first user; and
transmitting updated project data to said second user in real-time.

34. The method of claim 33 wherein said project data define an audiovisual collage.

35. The method of claim 34 wherein said transmitting updating project data to said second user occurs via a persistent connection.

36. The method of claim 34 wherein said modifications include zooming.

37. The method of claim 34 wherein said modifications include adding viewable text.

38. The method of claim 34 wherein said modifications include drawing.

39. The method of claim 34 wherein said modifications include cropping.

40. The method of claim 34 wherein said modifications include distorting.

41. The method of claim 34 wherein said modifications include stretching.

42. The method of claim 34 wherein said modifications include skewing.

43. The method of claim 34 wherein said modifications include translating.

44. The method of claim 34 wherein said modifications include rotating.

45. The method of claim 34 wherein said client program includes previewing.

46. The method of claim 34 wherein said client program includes federated search.

47. The method of claim 34 further comprising a chat application.

48. A method for real-time collaborative viewing and modification of multimedia data comprising:
allowing a first user to view multimedia data;
allowing a second user to view multimedia data;
transmitting data in pointer format to said first user's client;
transmitting data in pointer format to said second user's client;
accepting modifications to said project data from said first user; and
transmitting updated project data to said second user in real-time.

49. The method of claim 48 wherein said multimedia data define an audiovisual collage.

50. The method of claim 49 wherein said modifications include zooming.

51. The method of claim 49 wherein said modifications include adding viewable text.

52. The method of claim 49 wherein said modifications include drawing.

53. The method of claim 49 wherein said modifications include cropping.

54. The method of claim 49 wherein said modifications include distorting.

55. The method of claim 49 wherein said modifications include stretching.

56. The method of claim 49 wherein said modifications include skewing.

57. The method of claim 49 wherein said modifications include translating.

58. The method of claim 49 wherein said modifications include rotating.

59. The method of claim 49 wherein said client program includes previewing.

60. The method of claim 49 wherein said client program includes federated search.

61. The method of claim 49 further comprising a chat application.
